(19) United States
(12) Patent Application Publication
(10) Pub. No.: US 2024/0281732 A1
(43) Pub. Date: Aug. 22, 2024

(54) External Factor Driven Predictive Workload Optimization

(71) Applicant: International Business Machines Corporation, Armonk, NY (US)

(72) Inventors: Bader Ali-Saleh, Houston, TX (US); Brent William Yardley, Hillsboro, OR (US); Matthew Husley Caughman, Houston, TX (US); Franck Excoffier, Katy, TX (US); Rayyan Memon, Fulshear, TX (US)

(21) Appl. No.: 18/171,801

(22) Filed: Feb. 21, 2023

(51) Int. Cl. G06Q 10/0631; G06Q 10/0635

(52) U.S. Cl. CPC G06Q 10/06312; G06Q 10/0635

(57) ABSTRACT

Transferring data workloads is provided. A factor comparison is performed between each of a plurality of site profiles and a customer profile. A factor matching score is generated for each respective site profile of the plurality of site profiles based on the factor comparison. It is determined whether the factor matching score corresponding to a particular site profile is greater than or equal to a predefined minimum factor matching score threshold level. The particular site profile having the factor matching score greater than or equal to the predefined minimum factor matching score threshold level is selected as a recommended site profile for transferring a data workload of a customer to a set of target sites from a current site running the data workload. The recommended site profile is sent to a client device corresponding to the customer via a network.

### BACKGROUND

The disclosure relates generally to data management and more specifically to managing data workload migration between sites based on a plurality of factors.

Data management is the practice of ingesting, processing, securing, and storing an entity's data to support productivity. Data management includes ensuring high data availability and disaster recovery. High data availability refers to ensuring that data needed by an entity to function is accessible when and, where required, even when disruption occurs. High data availability is needed by many entities, such as, for example, banks, financial institutions, insurance companies, healthcare facilities, government agencies, businesses, and the like. Disaster recovery involves keeping all essential aspects of an entity functioning despite disruptive events, such as natural or human-induced disasters. As such, disaster recover can be considered a subset of business continuity. Disaster recovery assumes that the primary site is not immediately recoverable and restores data and services to a secondary site.

### SUMMARY

According to one illustrative embodiment, a computer-implemented method for transferring data workloads is provided. A computer performs a factor comparison between each of a plurality of site profiles and a customer profile. The computer generates a factor matching score for each respective site profile of the plurality of site profiles based on the factor comparison. The computer determines whether the factor matching score corresponding to a particular site profile is greater than or equal to a predefined minimum factor matching score threshold level. The computer selects the particular site profile having the factor matching score greater than or equal to the predefined minimum factor matching score threshold level as a recommended site profile for transferring a data workload of a customer to a set of target sites from a current site running the data workload in response to the computer determining that the factor matching score corresponding to the particular site profile is greater than or equal to the predefined minimum factor matching score threshold level. The computer sends the recommended site profile to a client device corresponding to the customer via a network. According to other illustrative embodiments, a computer system and computer program product for transferring data workloads are provided.

### BRIEF DESCRIPTION OF THE DRAWINGS

FIG. 1 is a pictorial representation of a computing environment in which illustrative embodiments may be implemented;

FIG. 2 is a diagram illustrating an example of a data workload management system in accordance with an illustrative embodiment; and

FIGS. 3A-3C are a flowchart illustrating a process for transferring data workloads in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

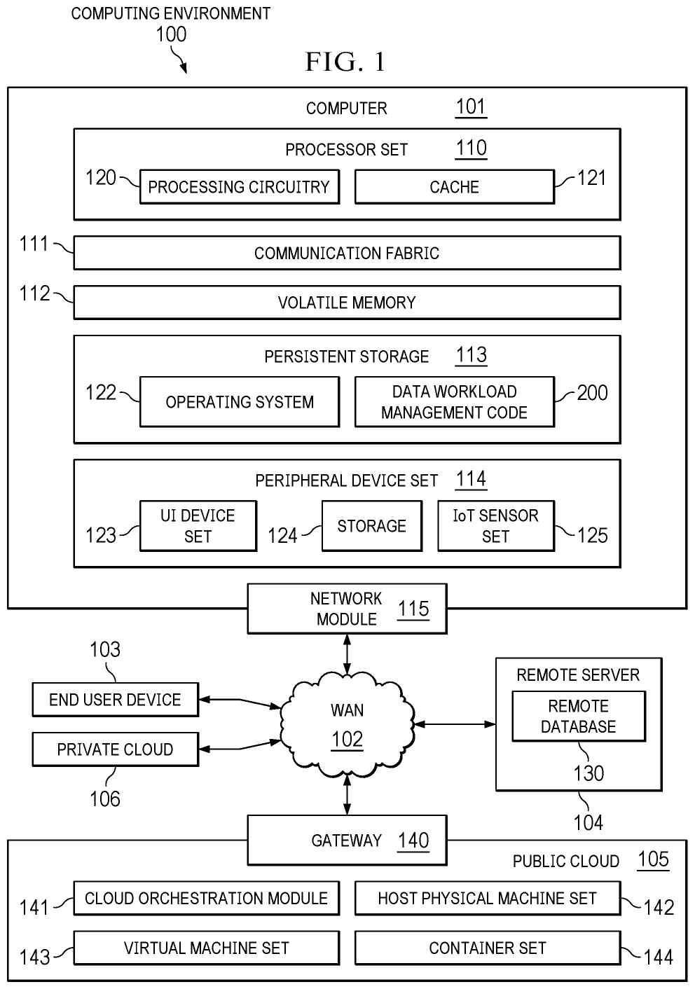

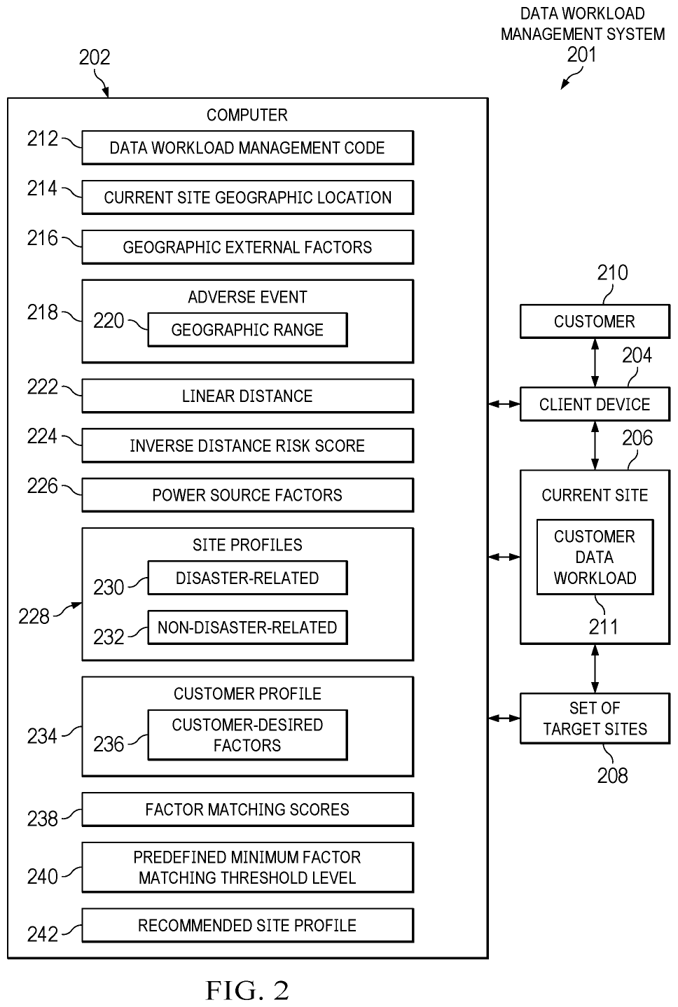

With reference now to the figures, and in particular, with reference to FIGS. 1-2, diagrams of data processing environments are provided in which illustrative embodiments may be implemented. It should be appreciated that FIGS. 1-2 are only meant as examples and are not intended to assert or imply any limitation with regard to the environments in which different embodiments may be implemented. Many modifications to the depicted environments may be made.

FIG. 1 shows a pictorial representation of a computing environment in which illustrative embodiments may be implemented. Computing environment 100 contains an example of an environment for the execution of at least some of the computer code involved in performing the inventive methods, such as data workload management code 200. For example, data workload management code 200 effectively controls movement of data workloads between sites based on a plurality of different factors to ensure data workload availability under disaster-related conditions and non-disaster-related conditions.

In addition to data workload management code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and data workload management code 200, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, mainframe computer, quantum computer, or any other form of computer now known or to be developed in the future that is capable of, for example, running a program, accessing a network, and querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in data workload management code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The data workload management code included in block 200 includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the internet. In various embodiments, UI device set 123 may include components such as a display screen, speaker, microphone, wearable devices (such as smart glasses), keyboard, mouse, and touchpad. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

EUD 103 is any computer system that is used and controlled by an end user (for example, a customer of an entity that operates computer 101), and may take any of the forms discussed above in connection with computer 101. EUD 103 typically receives helpful and useful data from the operations of computer 101. For example, in a hypothetical case where computer 101 is designed to provide a data workload migration recommendation to an end user, this data workload migration recommendation would typically be communicated from network module 115 of computer 101 through WAN 102 to EUD 103. In this way, EUD 103 can display, or otherwise present, the recommendation to the end user. In some embodiments, EUD 103 may be a client device, such as thin client, heavy client, mainframe computer, desktop computer, laptop computer, tablet computer, smartphone, and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a data workload migration recommendation based on historical data, then this data workload migration historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single entity. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As used herein, when used with reference to items, “a set of” means one or more of the items. For example, a set of clouds is one or more different types of cloud environments. Similarly, “a number of,” when used with reference to items, means one or more of the items. Moreover, “a group of” or “a plurality of” when used with reference to items, means two or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

Data centers oftentimes run under adverse conditions (e.g., subzero temperatures, heatwaves, hurricanes, tornados, floods, and the like). During adverse conditions, changes in datacenter usage should be taken into account. For example, a particular datacenter may typically have increased utilization during daylight hours wanting to utilize a certain amount of renewable solar energy to power the datacenter. However, due to prolonged heavy cloud cover in the geographic region of that particular datacenter, utilization of that particular datacenter may be negatively affected.

Also, operations of a datacenter may need to be moved during adverse conditions. Currently, several manual steps are needed to move operations off site to a disaster recovery site (e.g., disaster recovery requires the manual movement of hosts to the recovery site to resume normal operations). This manual process takes time and can leave users without service, which can have a negative impact on the service provider's reputation. Even in automated cases, such as HyperSwap® (a registered trademark of International Business Machines, Armonk, New York, U.S.A.), the failover sites are static targets. For example, HyperSwap provides dual-site access to a data volume. HyperSwap data volumes have a copy at one site and a copy at the other site. Data that is written to a volume is automatically sent to both copies. If one site is no longer available, then the other site can provide access to the volume. In other words, HyperSwap utilizes two synchronized storage controllers as multipath targets and accesses a secondary copy of the data when needed. However, when one site goes down due to a disaster or other reason, data redundancy is lost. In addition, HyperSwap cannot spin up a new target site.

Illustrative embodiments provide data workload optimization for sites (e.g., datacenters) having specific data workloads. Illustrative embodiments can also automatically move a specific data workload to a different site based on the specific data workload and a plurality of different factors. For example, illustrative embodiments are capable of adding and removing sites in different geographic locations based on the plurality of different factors, which can have an effect on the reliability and availability of a specific site, to determine whether a particular site is a valid target to transfer a particular data workload. Illustrative embodiments take into account and utilize the plurality of different factors, such as weather, heat index, power source, and the like, to spin up target sites anywhere around the world. For example, a customer may want a site to utilize a renewable power source to run the customer's data workload. Illustrative embodiments are capable of following availability of that renewable power source around the world to ensure that each target site, which is utilizing a renewable power source, is reliable and available for that particular data workload. A target site for a data workload can be, for example, a single computer system, mobile data processing device, or datacenter or a plurality of datacenters. Based on the plurality of different factors, illustrative embodiments generate disaster-related profiles and non-disaster-related profiles, which can include multiple target sites for data workloads, that closely match a customer profile created by a customer of the service provided by illustrative embodiments. Each respective disaster-related profile and non-disaster-related profile details a plan for transferring a customer's data workload from a site currently running the customer's data workload to a set of target sites based on the plurality of different factors, which include geographic external factors and power source factors.

A customer of the service provided by illustrative embodiments can avoid disasters by illustrative embodiments proactively moving data workloads to and from different sites when illustrative embodiments predict that an adverse condition or adverse event is highly likely to occur at the geographic location of a site corresponding to the customer. As a result, by illustrative embodiments proactively moving a data workload of a customer to a different site due to a predicted adverse condition or event, the customer can avoid a service outage that would have been caused by the predictable adverse condition or event and increase the customer's data workload continuity.

Illustrative embodiments monitor and collect a plurality of different geographic external factors, such as, for example, weather data, local activity data based on time, geolocation coordinates, country data, geographic range of external events, and the like, which correspond to a site, from a plurality of different data sources. Illustrative embodiments then generate a temporary storage object for the site, which is the beginning of a site profile corresponding to the site, that includes the collected plurality of different factors to determine whether the site is located within a geographic range of a predicted adverse condition or event and is at risk. For example, the country data includes a risk score from zero (0) indicating very low to no risk, which is good, to one (1) indicating very high risk, which is bad. The local activity data based on time can be, for example, current input/output operations per second (IOPS) over the average IOPS, which produces a risk score from 0 indicating very low to no risk, which is good, to 1 indicating very high risk, which is bad. Illustrative embodiments also multiply the country risk score by the local activity risk score to generate a combined risk score from 0, which is good, to 1, which is bad. Thus, illustrative embodiments return a country risk score, a local activity risk score, and a country/local activity combined risk score.

In addition, the current weather data includes a risk score from 0 indicating very low to no risk, which is good, to 1 indicating very high risk, which is bad, depending on the severity of the weather risk in the geographic region around the site. Illustrative embodiments can receive the weather data from, for example, a weather service, weather channel, or the like on a predetermined time interval basis, such as hourly. Illustrative embodiments utilize the geolocation coordinates (e.g., latitude and longitude) of the site to determine whether any predicted adverse condition or event will occur near the site and provide a geographic risk score from 0 indicating very low to no risk, which is good, to 1 indicating very high risk, which is bad. For example, illustrative embodiments calculate a linear distance from the geolocation coordinates of the site to each predicted adverse condition or event, which can be a geographic range, line, or point depending on that particular condition or event for the geographic risk factor (e.g., predicted hurricane path, tornado path, polar storm path, torrential rain path, flood range, high temperature area, coastline, fault line, earthquake epicenter, or the like). Furthermore, illustrative embodiments calculate an inverse distance risk score for each predicted risk (i.e., each predicted adverse condition or event) based on its corresponding linear distance from the geolocation coordinates of the site. In other words, a decreased distance between the geolocation coordinates of the site and a particular predicted risk (i.e., predicted adverse condition or event) equals an increased geographic risk score. Conversely, an increased distance between the geolocation coordinates of the site and a particular predicted risk (i.e., predicted adverse condition or event) equals a decreased geographic risk score. Illustrative embodiments drop or remove predicted risks (i.e., predicted adverse conditions or events) that have a corresponding risk score of 0 or approximately 0. As a result, illustrative embodiments output to the temporary storage object for the site a plurality of external risk scores that includes a country risk score, a local activity risk score, a country/local activity combined risk score, a current weather risk score, a geographic risk score, a combined linear distance/geographic risk score, and a combined linear distance/current weather risk score.

Moreover, illustrative embodiments also collect a plurality of power source factors associated with powering the site currently running the customer's data workload. The plurality of power source factors includes, for example, site power source characteristics (e.g., electric, natural gas, propane, hydroelectric, wind, solar, and the like), daylight hours, wind speed, water level, fuel supply, and the like based on time of year and time of day historically and on average. Illustrative embodiments add these power source factors to the temporary storage object for the site.

In addition, illustrative embodiments determine a site power source risk score as related to each respective external risk score of the plurality of external risk scores listed above based on time of year and time of day (e.g., increased IOPS during daylight hours equals an increased site power source risk score for a site power source failure due to a predicted adverse condition or event and decreased IOPS during nighttime hours equals a decreased site power source risk score for a site power source failure due to a predicted adverse condition or event). In other words, illustrative embodiments multiple each respective external risk score of the plurality of external risk scores listed above by the site power source risk score for the time of day. Illustrative embodiments can also determine a power risk score for renewable power sources (e.g., a renewable solar power source risk score based on amount of daylight, or a renewable wind power source risk score based on wind speed). Illustrative embodiments output to the temporary storage object for the site from this step a plurality of power source risk scores that includes a country risk score, a local activity risk score, a country/local activity combined risk score, a current weather risk score, a geographic risk score, a combined linear distance/geographic risk score, a combined linear distance/current weather risk score, and a list of time-of-day site power source risk scores corresponding to respective external risk scores listed above.

Subsequently, illustrative embodiments generate a site profile for the site, which includes aggregate risk scores for the site based on all of the information collected above. For example, when generating the site profile, illustrative embodiments combine all of the external risk scores to generate an aggregate external risk score and combine all of the power source risk scores to generate an aggregate power source risk score that correspond to the site. Further, illustrative embodiments can generate an overall risk score for the site based on the aggregate external risk score and the aggregate power source risk score corresponding to the site.

Also, illustrative embodiments can generate up to a predefined maximum number of site profiles (e.g., 2, 3, 4, 5, 10, 15, 20, or any other number of profiles) that at least match the two aggregate risk scores (i.e., the aggregate external risk score and the aggregate power source risk score) or the overall risk score corresponding to the site. It should be noted that the profiles can include disaster-related profiles (e.g., profiles related to transferring data workloads to different target sites due to natural disasters or human-induced disasters) and non-disaster-related profiles (e.g., profiles related to transferring data workloads to utilize renewable power sources for target green sites around the world). The profiles can also consider other sites (e.g., other computer systems, datacenters, or the like) to generate same risk scores as with the previous site, consider other power sources to generate same risk scores as with the previous power source, consider historic data, and the like.

Each respective profile of the predefined maximum number of profiles considers 3 characteristics (e.g., attributes, features, traits, or the like) corresponding to the customer's data workload. The 3 characteristics are: 1) data distribution between sites (i.e., more than one target site for the data to be transferred to); 2) data throughput between the sites; and 3) data redundancy between the sites. In other words, each respective profile (e.g., disaster-related profile or non-disaster-related profile) includes a plan that takes into account data distribution, data throughput, and data redundancy for transferring a customer's data workload between sites.

Illustrative embodiments can also generate profiles for the extremes of each data characteristic (e.g., data distribution would try to minimize the number of copies by creating more data parity between target sites, data throughput would have one site to process the data, and data redundancy would try to maximize the number of copies between sites). Further, illustrative embodiments can generate some profiles that lean between each data characteristic, and generate some profiles balanced with the overall risk score for the site.

Illustrative embodiments can then utilize information in the profiles to add a set of target recovery sites, secondary sites, and additional sites to the profiles. Also, the addition of sites can depend on the particular profile (e.g., a profile for data redundancy would add more target sites). However, it should be noted that the number of target sites will not exceed the total number of target sites the customer is currently utilizing or can utilize. These sites can provide feedback to illustrative embodiments to increase predictive accuracy.

Illustrative embodiments also retrieve a customer profile that contains a set of customer-desired factors for a target site, which matches the customer's current needs or situation (e.g., renewable energy mode, lowest overall risk, lowest latency, and the like). Illustrative embodiments perform a factor comparison between the plurality of generated site profiles and the customer profile (e.g., comparing the plurality of geographic external and power source factors in the generated site profiles with the customer-desired factors in the customer profile). Illustrative embodiments generate a factor matching score for each respective site profile based on the comparison. Illustrative embodiments then determine whether the factor matching score corresponding to a particular site profile is greater than or equal to a predefined minimum factor matching score threshold level (e.g., 75% matching, 80% matching, 85% matching, 90% matching, or the like).

If illustrative embodiments determine that a particular site profile has a factor matching score greater than or equal to the predefined minimum factor matching score threshold level, then illustrative embodiments recommend transferring the data workload of the customer to a set of target sites corresponding to that particular site profile. Illustrative embodiments can also recommend more than one site profile to the customer depending on the customer's wants or needs.

If illustrative embodiments determine that no site profile has a factor matching score greater than or equal to the predefined minimum factor matching score threshold level, then illustrative embodiments generate an intersectional site profile based on the plurality of generated site profiles. For example, illustrative embodiments select a predefined number (e.g., 2, 3, 4, or the like) of site profiles having a highest factor matching score to generate the intersectional site profile in accordance with the customer profile.

Illustrative embodiments can repeat the entire process above on demand, on a predefined time interval basis, or on a customer-defined time interval basis. Thus, illustrative embodiments collect a plurality of factors for disaster-related situations and for non-disaster-related situations to generate disaster-related and non-disaster-related site profiles based on these factors. The output of illustrative embodiments is a site profile that is closely related to the customer's needs or situation.

As an illustrative example scenario, a particular customer may want to be in disaster situation (e.g., hurricane) because that may be the only way to process real time data regarding the disaster fast enough. Consequently, the customer's input profile would not weight weather as much as with other factors. As a result, illustrative embodiments would generate a site profile that would accommodate the customer's decreased concern for weather by making weather a secondary factor. In other words, illustrative embodiments would still consider weather, but not as much as the other customer-desired factors.

As another illustrative example scenario, a particular customer may want to just utilize a renewable power source to run the customer's data workload. As a result, illustrative embodiments would generate a site profile that takes renewable power sources as a primary factor. For example, illustrative embodiments would generate a site profile that would, for example, move the customer's data workload to different target sites around the world following the sun in order to rely on solar energy as the renewable power source according to the customer's desires.

As a result, illustrative embodiments increase data workload continuity of customers by automatically transferring data workloads when illustrative embodiments predict adverse events. In addition, illustrative embodiments decrease service outages that can be experienced by customers due to predicted adverse events, such as disasters. Further, illustrative embodiments avoid human error with regard to adverse event predictions and manual movement of data workloads.

Thus, illustrative embodiments provide one or more technical solutions that overcome a technical problem with manual movement of data workloads between sites. As a result, these one or more technical solutions provide a technical effect and practical application in the field of data workload management.

With reference now to FIG. 2, a diagram illustrating an example of a data workload management system is depicted in accordance with an illustrative embodiment. Data workload management system 201 may be implemented in a computing environment, such as computing environment 100 in FIG. 1. Data workload management system 201 is a system of hardware and software components for controlling the migration of data workloads between sites based on a plurality of different factors to ensure data workload availability and continuity during disaster-related conditions and non-disaster-related conditions.

In this example, data workload management system 201 includes computer 202, client device 204, current site 206, and set of target sites 208. Computer 202 and client device 204 may be, for example, computer 101 and EUD 103, respectively, in FIG. 1. Current site 206 may be, for example, remote server 104 in FIG. 1. Set of target sites 208 may be, for example, host physical machine set 142 in FIG. 1. However, it should be noted that data workload management system 201 is intended as an example only and not as a limitation on illustrative embodiments. For example, data workload management system 201 can include any number of computers, client devices, current sites, sets of target sites, and other devices and components not shown.

Customer 210 utilizes client device 204 to send a request to computer 202 for computer 202 to determine whether transfer of customer data workload 211 to set of target sites 208 from current site 206 is needed. Customer data workload 211 corresponds to customer 210. Customer 210 can be, for example, an individual or an entity, such as a business, company, enterprise, organization, institution, agency, or the like. Current site 206 represents the site that is currently running customer data workload 211 for customer 210.

Customer data workload 211 can be any type of data workload. A data workload is data captured by an application for processing and storage. A data workload can be a transactional data workload (e.g., a database transactional application, such as a booking application, shopping website, or the like, that captures, processes, and stores information corresponding to transactions), an analytical data workload (e.g., a decision support application that derives business value from data captured by other applications, such as transactional applications), or a translytical data workload (e.g., an application that supports hybrid transactional/analytical processing from data captured by transactional and analytical data workloads).

Set of target sites 208 represents one or more target sites that will receive customer data workload 211 from current site 206 in response to data workload management code 212 of computer 202 determining that transfer of customer data workload 211 from current site 206 to set of target sites 208 is needed based on a plurality of different factors. Data workload management code 212 may be, for example, data workload management code 200 in FIG. 1.

In response to receiving the request from customer 210 via client device 204, data workload management code 212 determines current site geographic location 214. Current site geographic location 214 represents the current geographic location of current site 206 based on, for example, GPS coordinates. In addition, data workload management code 212 identifies geographic external factors 216, which correspond to current site geographic location 214. Geographic external factors 216 can include, for example, a country factor, a local activity factor, a combined country/local activity factor, a current weather factor, geographic risk factors, and the like.

Based on performing an analysis of geographic external factors 216, data workload management code 212 predicts whether adverse event 218 will occur. Adverse event 218 can represent any type of event or condition (e.g., disaster event such as a typhoon or non-disaster event such as lack of sunlight for a solar powered site or not enough or too much wind for a wind powered site), which will have a negative effect on current site 206 running customer data workload 211. If data workload management code 212 predicts that adverse event 218 will occur, then data workload management code 212 determines geographic range 220 of adverse event 218. In addition, data workload management code 212 determines whether current site 206 is within geographic range 220 of adverse event 218 based on current site geographic location 214 of current site 206.

If data workload management code 212 determines that current site 206 is within geographic range 220 of adverse event 218, then data workload management code 212 determines linear distance 222 between current site geographic location 214 of current site 206 and adverse event 218. Further, data workload management code 212 determines inverse distance risk score 224 based on linear distance 222 between current site geographic location 214 of current site 206 and adverse event 218.

If data workload management code 212 determines that inverse distance risk score 224 is greater than or equal to a defined maximum inverse distance risk score threshold level, then data workload management code 212 determines that current site 206 is at risk and identifies power source factors 226, which correspond to current site 206. Power source factors 226 can include, for example, identification of the power source of current site 206 (e.g., one or more of electric, natural gas, propane, hydroelectric, wind, solar, or the like) based on time of year and time of day both historically and on average.

Data workload management code 212 generates site profiles 228 based on geographic external factors 216 and power source factors 226. Site profiles 228 represent a plurality of site profiles corresponding to current site 206 and includes a set of disaster-related profiles 230 and a set of non-disaster-related profiles 232. Furthermore, data workload management code 212 retrieves customer profile 234, which corresponds to customer 210. Customer profile 234 includes customer-desired factors 236. Customer-desired factors 236 represent a plurality of different characteristics or features that customer 210 wants a target site to have or utilize (e.g., use renewable energy, have high data throughput, have low network latency, and the like).

Data workload management code 212 performs factor matching between the factors contained in site profiles 228 and customer-desired factors 236 contained in customer profile 234. Based on the factor matching, data workload management code 212 generates factor matching scores 238 for site profiles 228. Factor matching scores 238 include a factor matching score for each respective site profile of site profiles 228. A factor matching score represents an amount, degree, or percentage of similarity between a particular site profile of site profiles 228 and customer profile 234.

Data workload management code 212 compares the factor matching score of each respective site profile of site profiles 228 with predefined minimum factor matching threshold level 240. Predefined minimum factor matching threshold level 240 may be, for example, 75%, 80%, 85%, or 90% factor matching between profiles. If a particular site profile has a factor matching score greater than or equal to predefined minimum factor matching threshold level 240, then data workload management code 212 selects that particular site profile as recommended site profile 242. If more than one site profile has a factor matching score greater than or equal to predefined minimum factor matching threshold level 240, then data workload management code 212 may select the site profile having the highest factor matching score as recommended site profile 242.

Data workload management code 212 sends recommended site profile 242 to customer 210 for review and possible modifications. If no modifications are received from customer 210, then data workload management code 212 automatically implements recommended site profile 242 to transfer customer data workload 211 to set of target sites 208 from current site 206. If customer 210 sends modifications regarding recommended site profile 242, then data workload management code 212 implements the received modifications to recommended site profile 242. Afterward, data workload management code 212 transfers customer data workload 211 to set of target sites 208 from current site 206 based on the implemented modifications to recommended site profile 242.

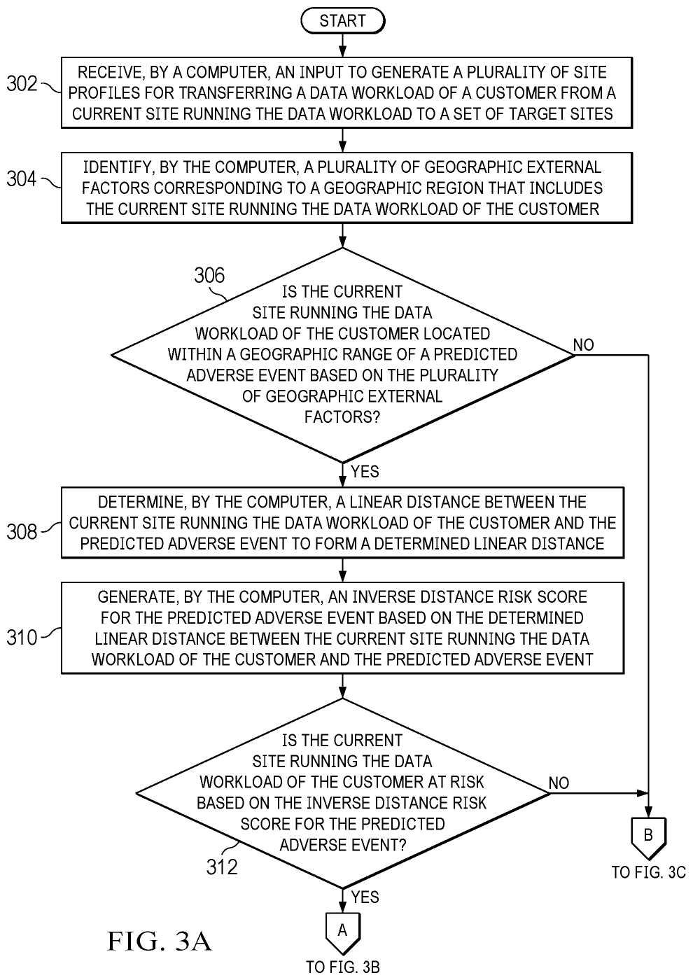

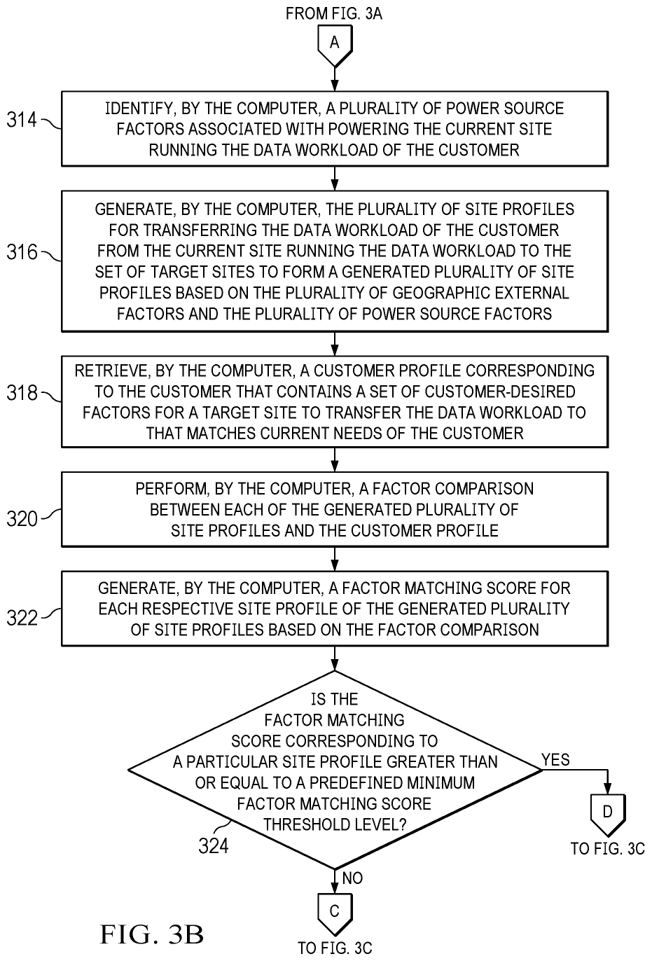

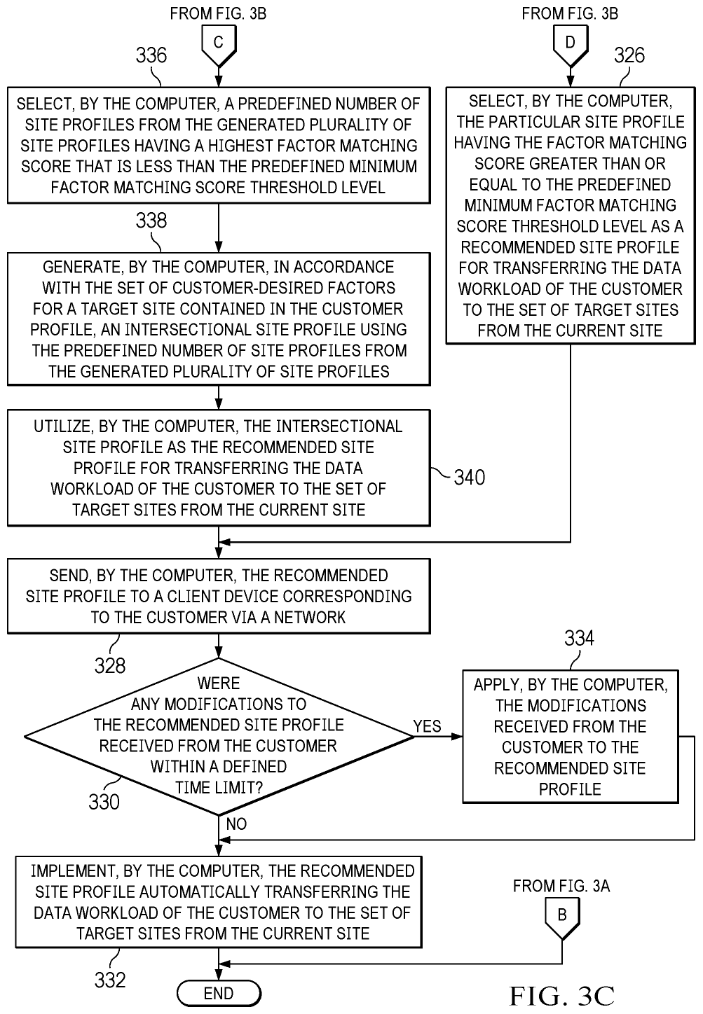

With reference now to FIGS. 3A-3C, a flowchart illustrating a process for transferring data workloads is shown in accordance with an illustrative embodiment. The process shown in FIGS. 3A-3C may be implemented in a computer, such as, for example, computer 101 in FIG. 1. For example, the process shown in FIGS. 3A-3C may be implemented in data workload management code 200 in FIG. 1 or data workload management code 212 in FIG. 2.

The process begins when the computer receives an input to generate a plurality of site profiles for transferring a data workload of a customer from a current site running the data workload to a set of target sites (step 302). The computer identifies a plurality of geographic external factors corresponding to a geographic region that includes the current site running the data workload of the customer in response to receiving the input (step 304).

The computer makes a determination as to whether the current site running the data workload of the customer is located within a geographic range of a predicted adverse event based on the plurality of geographic external factors (step 306). If the computer determines that the current site running the data workload of the customer is not located within the geographic range of the predicted adverse event based on the plurality of geographic external factors, no output of step 306, then the process terminates thereafter. If the computer determines that the current site running the data workload of the customer is located within the geographic range of the predicted adverse event based on the plurality of geographic external factors, yes output of step 306, then the computer determines a linear distance between the current site running the data workload of the customer and the predicted adverse event to form a determined linear distance (step 308).

In addition, the computer generates an inverse distance risk score for the predicted adverse event based on the determined linear distance between the current site running the data workload of the customer and the predicted adverse event (step 310). The computer makes a determination as to whether the current site running the data workload of the customer is at risk based on the inverse distance risk score for the predicted adverse event (step 312). If the computer determines that the current site running the data workload of the customer is not at risk based on the inverse distance risk score for the predicted adverse event, no output of step 312, then the process terminates thereafter. If the computer determines that the current site running the data workload of the customer is at risk based on the inverse distance risk score for the predicted adverse event, yes output of step 312, then the computer identifies a plurality of power source factors associated with powering the current site running the data workload of the customer (step 314).

Afterward, the computer generates the plurality of site profiles for transferring the data workload of the customer from the current site running the data workload to the set of target sites to form a generated plurality of site profiles based on the plurality of geographic external factors and the plurality of power source factors (step 316). The generated plurality of site profiles includes a set of disaster-related site profiles and a set of non-disaster-related site profiles. Further, the computer retrieves a customer profile corresponding to the customer that contains a set of customer-desired factors for a target site to transfer the data workload to that matches current needs of the customer (step 318).

The computer performs a factor comparison between each of the generated plurality of site profiles and the customer profile (step 320). The computer generates a factor matching score for each respective site profile of the generated plurality of site profiles based on the factor comparison (step 322). The computer makes a determination as to whether the factor matching score corresponding to a particular site profile is greater than or equal to a predefined minimum factor matching score threshold level (step 324).

If the computer determines that the factor matching score corresponding to a particular site profile is greater than or equal to the predefined minimum factor matching score threshold level, yes output of step 324, then the computer selects the particular site profile having the factor matching score greater than or equal to the predefined minimum factor matching score threshold level as a recommended site profile for transferring the data workload of the customer to the set of target sites from the current site (step 326). The computer sends the recommended site profile to a client device corresponding to the customer via a network (step 328).

The computer makes a determination as to whether any modifications to the recommended site profile were received from the customer within a defined time limit (step 330). If the computer determines that no modifications to the recommended site profile were not received from the customer within the defined time limit, no output of step 330, then the computer implements the recommended site profile automatically transferring the data workload of the customer to the set of target sites from the current site (step 332). Thereafter, the process terminates. If the computer determines that a set of modifications to the recommended site profile were received from the customer within the defined time limit, yes output of step 330, then the computer applies the set of modifications received from the customer to the recommended site profile (step 334). Thereafter, the process returns to step 332 where the computer automatically implements the recommended site profile.

Returning again to step 324, if the computer determines that no factor matching score corresponding to the generated plurality of site profiles is greater than or equal to the predefined minimum factor matching score threshold level, no output of step 324, then the computer selects a predefined number of site profiles from the generated plurality of site profiles having a highest factor matching score that is less than the predefined minimum factor matching score threshold level (step 336). Afterward, the computer, in accordance with the set of customer-desired factors for a target site contained in the customer profile, generates an intersectional site profile using the predefined number of site profiles from the generated plurality of site profiles (step 338). The computer utilizes the intersectional site profile as the recommended site profile for transferring the data workload of the customer to the set of target sites from the current site (step 340). Thereafter, the process returns to step 328 where the computer sends the recommended site profile to the client device of the customer via the network.

Thus, illustrative embodiments of the present invention provide a computer-implemented method, computer system, and computer program product for managing migration of data workloads between sites based on a plurality of different factors. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for transferring data workloads, the computer-implemented method comprising:
performing, by a computer, a factor comparison between each of a plurality of site profiles and a customer profile;
generating, by the computer, a factor matching score for each respective site profile of the plurality of site profiles based on the factor comparison;
determining, by the computer, whether the factor matching score corresponding to a particular site profile is greater than or equal to a predefined minimum factor matching score threshold level;
selecting, by the computer, the particular site profile having the factor matching score greater than or equal to the predefined minimum factor matching score threshold level as a recommended site profile for transferring a data workload of a customer to a set of target sites from a current site running the data workload in response to the computer determining that the factor matching score corresponding to the particular site profile is greater than or equal to the predefined minimum factor matching score threshold level; and
sending, by the computer, the recommended site profile to a client device corresponding to the customer via a network.

2. The computer-implemented method of claim 1, further comprising:
selecting, by the computer, a predefined number of site profiles from the plurality of site profiles having a highest factor matching score that is less than the predefined minimum factor matching score threshold level in response to the computer determining that no factor matching score corresponding to the plurality of site profiles is greater than or equal to the predefined minimum factor matching score threshold level;
generating, by the computer, in accordance with a set of customer-desired factors for a target site contained in the customer profile, an intersectional site profile using the predefined number of site profiles from the plurality of site profiles; and
utilizing, by the computer, the intersectional site profile as the recommended site profile for transferring the data workload of the customer to the set of target sites from the current site.

3. The computer-implemented method of claim 1, further comprising:
determining, by the computer, whether modifications to the recommended site profile were received from the customer within a defined time limit; and
implementing, by the computer, the recommended site profile automatically transferring the data workload of the customer to the set of target sites from the current site in response to the computer determining that no modifications to the recommended site profile were not received from the customer within the defined time limit.

4. The computer-implemented method of claim 3, further comprising:
applying, by the computer, the modifications received from the customer to the recommended site profile in response to the computer determining that the modifications to the recommended site profile were received from the customer within the defined time limit.

5. The computer-implemented method of claim 1, further comprising:
receiving, by the computer, an input to generate the plurality of site profiles for transferring the data workload of the customer from the current site running the data workload to the set of target sites; and
identifying, by the computer, a plurality of geographic external factors corresponding to a geographic region that includes the current site running the data workload of the customer in response to receiving the input.

6. The computer-implemented method of claim 5, further comprising:
determining, by the computer, whether the current site running the data workload of the customer is located within a geographic range of a predicted adverse event based on the plurality of geographic external factors;
determining, by the computer, a linear distance between the current site running the data workload of the customer and the predicted adverse event in response to the computer determining that the current site running the data workload of the customer is located within the geographic range of the predicted adverse event based on the plurality of geographic external factors; and
generating, by the computer, an inverse distance risk score for the predicted adverse event based on the linear distance between the current site running the data workload of the customer and the predicted adverse event.

7. The computer-implemented method of claim 6, further comprising:
determining, by the computer, whether the current site running the data workload of the customer is at risk based on the inverse distance risk score for the predicted adverse event; and
identifying, by the computer, a plurality of power source factors associated with powering the current site running the data workload of the customer.

8. The computer-implemented method of claim 7, further comprising:
generating, by the computer, the plurality of site profiles for transferring the data workload of the customer from the current site running the data workload to the set of target sites based on the plurality of geographic external factors and the plurality of power source factors; and
retrieving, by the computer, the customer profile corresponding to the customer that contains a set of customer-desired factors for a target site to transfer the data workload to that matches current needs of the customer.

9. The computer-implemented method of claim 1, wherein the plurality of site profiles includes a set of disaster-related site profiles and a set of non-disaster-related site profiles.

10. The computer-implemented method of claim 1, wherein each site profile of the plurality of site profiles considers data distribution between sites, data throughput between the sites, and data redundancy between the sites.

11. A computer system for transferring data workloads, the computer system comprising:
a communication fabric;
a storage device connected to the communication fabric, wherein the storage device stores program instructions; and
a processor connected to the communication fabric, wherein the processor executes the program instructions to:
perform a factor comparison between each of a plurality of site profiles and a customer profile;
generate a factor matching score for each respective site profile of the plurality of site profiles based on the factor comparison;
determine whether the factor matching score corresponding to a particular site profile is greater than or equal to a predefined minimum factor matching score threshold level;
select the particular site profile having the factor matching score greater than or equal to the predefined minimum factor matching score threshold level as a recommended site profile for transferring a data workload of a customer to a set of target sites from a current site running the data workload in response to determining that the factor matching score corresponding to the particular site profile is greater than or equal to the predefined minimum factor matching score threshold level; and
send the recommended site profile to a client device corresponding to the customer via a network.

12. The computer system of claim 11, wherein the processor further executes the program instructions to:
select a predefined number of site profiles from the plurality of site profiles having a highest factor matching score that is less than the predefined minimum factor matching score threshold level in response to determining that no factor matching score corresponding to the plurality of site profiles is greater than or equal to the predefined minimum factor matching score threshold level;
generate, in accordance with a set of customer-desired factors for a target site contained in the customer profile, an intersectional site profile using the predefined number of site profiles from the plurality of site profiles; and
utilize the intersectional site profile as the recommended site profile for transferring the data workload of the customer to the set of target sites from the current site.

13. A computer program product for transferring data workloads, the computer program product comprising a computer-readable storage medium having program instructions embodied therewith, the program instructions executable by a computer to cause the computer to perform a method of:
performing, by the computer, a factor comparison between each of a plurality of site profiles and a customer profile;
generating, by the computer, a factor matching score for each respective site profile of the plurality of site profiles based on the factor comparison;
determining, by the computer, whether the factor matching score corresponding to a particular site profile is greater than or equal to a predefined minimum factor matching score threshold level;
selecting, by the computer, the particular site profile having the factor matching score greater than or equal to the predefined minimum factor matching score threshold level as a recommended site profile for transferring a data workload of a customer to a set of target sites from a current site running the data workload in response to the computer determining that the factor matching score corresponding to the particular site profile is greater than or equal to the predefined minimum factor matching score threshold level; and
sending, by the computer, the recommended site profile to a client device corresponding to the customer via a network.

14. The computer program product of claim 13, further comprising:
selecting, by the computer, a predefined number of site profiles from the plurality of site profiles having a highest factor matching score that is less than the predefined minimum factor matching score threshold level in response to the computer determining that no factor matching score corresponding to the plurality of site profiles is greater than or equal to the predefined minimum factor matching score threshold level;
generating, by the computer, in accordance with a set of customer-desired factors for a target site contained in the customer profile, an intersectional site profile using the predefined number of site profiles from the plurality of site profiles; and
utilizing, by the computer, the intersectional site profile as the recommended site profile for transferring the data workload of the customer to the set of target sites from the current site.

15. The computer program product of claim 13, further comprising:
determining, by the computer, whether modifications to the recommended site profile were received from the customer within a defined time limit; and
implementing, by the computer, the recommended site profile automatically transferring the data workload of the customer to the set of target sites from the current site in response to the computer determining that no modifications to the recommended site profile were not received from the customer within the defined time limit.

16. The computer program product of claim 15, further comprising:
applying, by the computer, the modifications received from the customer to the recommended site profile in response to the computer determining that the modifications to the recommended site profile were received from the customer within the defined time limit.

17. The computer program product of claim 13, further comprising:
receiving, by the computer, an input to generate the plurality of site profiles for transferring the data workload of the customer from the current site running the data workload to the set of target sites; and
identifying, by the computer, a plurality of geographic external factors corresponding to a geographic region that includes the current site running the data workload of the customer in response to receiving the input.

18. The computer program product of claim 17, further comprising:
determining, by the computer, whether the current site running the data workload of the customer is located within a geographic range of a predicted adverse event based on the plurality of geographic external factors;
determining, by the computer, a linear distance between the current site running the data workload of the customer and the predicted adverse event in response to the computer determining that the current site running the data workload of the customer is located within the geographic range of the predicted adverse event based on the plurality of geographic external factors; and
generating, by the computer, an inverse distance risk score for the predicted adverse event based on the linear distance between the current site running the data workload of the customer and the predicted adverse event.

19. The computer program product of claim 18, further comprising:
determining, by the computer, whether the current site running the data workload of the customer is at risk based on the inverse distance risk score for the predicted adverse event; and
identifying, by the computer, a plurality of power source factors associated with powering the current site running the data workload of the customer.

20. The computer program product of claim 19, further comprising:
generating, by the computer, the plurality of site profiles for transferring the data workload of the customer from the current site running the data workload to the set of target sites based on the plurality of geographic external factors and the plurality of power source factors; and
retrieving, by the computer, the customer profile corresponding to the customer that contains a set of customer-desired factors for a target site to transfer the data workload to that matches current needs of the customer.
